(19) United States
(12) Patent Application Publication
(10) Pub. No.: US 2023/0316231 A1
(43) Pub. Date: Oct. 5, 2023

(54) SYSTEM FOR FACILITATING AND GAMIFYING THE JOB HUNTING PROCESS

(71) Applicant: Yesenia Lavin, Howard Beach, NY (US)

(72) Inventor: Yesenia Lavin, Howard Beach, NY (US)

(21) Appl. No.: 18/128,614

(22) Filed: Mar. 30, 2023

Related U.S. Application Data
(60) Provisional application No. 63/325,475, filed on Mar. 30, 2022.

(51) Int. Cl. G06Q 10/1053

(52) U.S. Cl. CPC G06Q 10/1053

(57) ABSTRACT

A system for facilitating job hunting via a gamification is disclosed. The system includes a resume generator to facilitate the user-generation of a resume and transmit a completed resume to a database. An OCR engine analyzes the completed resume and provide feedback and permit the user to edit the resume. The completed resume is transmitted to one or more user-selected employers. The user can follow-up with the submission of the completed resume to increase their chances of an interview or becoming employed. A gamification engine gamifies one or more processes in the job hunting process.

### CROSS-REFERENCE TO RELATED APPLICATIONS

The present application claims priority to U.S. Provisional Application No. 63/325,475 filed Mar. 30, 2022, titled “SYSTEM FOR FACILITATING AND GAMIFYING THE JOB HUNTING PROCESS” which is hereby incorporated by reference in its entirety.

### TECHNICAL FIELD

The embodiments generally relate to computerized systems for facilitating the job hunting process.

### BACKGROUND

Currently, there are a number of solutions for transmitting and tracking the status of job applications. Some of these solutions attempt to fix the daunting process of looking for employment, but these solutions fail to meet the needs of the industry because there's too many repetitive steps or manual steps for the applicant to follow and/or keep up with. It only slightly works with people who are computer savvy or very organized to go back and update the steps manually. Other solutions attempt to offer help in one or two steps only, leaving the applicant on their own to figure out the remainder of the process. However, these solutions are similarly unable to meet the needs of the industry because the applicants are being exposed all equally regardless of age and experience. Furthermore, transmitting the same resume to multiple jobs does not account for each companies' algorithms of key words that they are looking to pull from resume's submissions. Still, other solutions seek to offer a platform with personalized coaching help, but these solutions also fail to meet industry needs because the average unemployed person cannot afford expenses beyond basic living necessities, or the basic fees of paying for the job procurement service.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a system for facilitating job hunting via a gamification. The system includes a resume generator to facilitate the user-generation of a resume and transmit a completed resume to a database. An OCR engine analyzes the completed resume and provide feedback and permit the user to edit the resume. The completed resume is transmitted to one or more user-selected employers. The user can follow-up with the submission of the completed resume to increase their chances of an interview or becoming employed. A gamification engine gamifies one or more processes in the job hunting process. Each game includes a unique gamification interface, as well as its own scoring system to incentivize the user.

The system provides a fun and easy way to find jobs and easy accountability with each job submission. Its unique function of breaking through companies' algorithms and gatekeepers aid the placing of the user's resume(s) ahead of the competition. The software tailors each resume to each specific job post that the user shows an interest towards. The system provides suggestions for key words and word phrases that the employer is looking to find in submitted resumes and helps create a natural flowing resume keeping the reader enticed. A recommendation engine provides recommendations in resume formulation to aid in the resume creation process. Similarly, the system provides a questionnaire to define the functionality of the subsequent games that are nonexistent in other platforms. Also, with its standard integration the system organizes the user's application history as well as their high ranked saved jobs and follow up activities. A scoring algorithm incentivizes users to interact with the system and meet their pre-selected goals. The location services geo track the user's desired location for each of their employment interests.

In one aspect, the system includes in artificial intelligence (AI) engine receives information from the OCR engine and recommendation engine to search various databases and Internet sources to select terms, skills, and other information to aid in the resume creation process.

In one aspect, the AI engine inspects selected resumes to match the resume to one or more job posts and/or descriptions. The system may then suggest, via the AI engine, adjustments to the resume to allow the user to apply to the suggested job opening.

In one aspect, the user may select a preferred location or set of locations which they would like to work. The preferred location may then filter where the application is transmitted to based on where the available job is located.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the system infrastructure and connected network, according to some embodiments;

FIG. 2 illustrates a flowchart of the questions provided to the user, according to some embodiments;

FIG. 3 illustrates screenshots of the video resume interface, according to some embodiments;

FIG. 4 illustrates a flowchart of the resume upload options, according to some embodiments;

FIG. 5 illustrates a flowchart of the resume builder, according to some embodiments;

FIG. 6 illustrates the location services platform, according to some embodiments;

FIG. 7 illustrates a screenshot of the web extension associated with the system, according to some embodiments;

FIG. 8 illustrates a screenshot of the dashboard, according to some embodiments;

FIG. 9 illustrates a screenshot of the Star Stamp interface, according to some embodiments;

FIG. 10 illustrates a screenshot of the Star Ratings interface, according to some embodiments;

FIG. 11 illustrates a screenshot of the Star Stamp completion interface, according to some embodiments;

FIG. 12 illustrates a screenshot of the Job Inspector interface, according to some embodiments;

FIG. 13 illustrates the OCR component of the Job Inspector, according to some embodiments;

FIG. 14 illustrates the OCR component of the Job Inspector, according to some embodiments;

FIG. 15 illustrates a screenshot of the Job Inspector completion interface, according to some embodiments;

FIG. 16 illustrates a screenshot of the “GET HIRED” introduction interface, according to some embodiments;

FIG. 17 illustrates screenshots of the application interface, according to some embodiments;

FIG. 18 illustrates a screenshot of the resume completion interface, according to some embodiments;

FIG. 19 illustrates a screenshot of the Circle Back interface, according to some embodiments;

FIG. 20 illustrates a screenshot of the main interface, according to some embodiments;

FIG. 21 illustrates a screenshot of the Volunteer interface, according to some embodiments;

FIG. 22 illustrates a screenshot of the introduction to the volunteering system, according to some embodiments;

FIG. 23 illustrates a screenshot of the volunteering completion page, according to some embodiments;

FIG. 24 illustrates a screenshot of the Stand Out interface, according to some embodiments;

FIG. 25 illustrates a screenshot of the settings interface, according to some embodiments;

and

FIG. 26 illustrates a block diagram of the application program in operable communication with the computing system, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a system to facilitate job-hunting which include an online gaming system. The core components that together make up the architecture of the system are a database system that intelligently helps users complete job applications of interest. Generally speaking, these components are structured such that the software can recognize common phrases and word combinations to complete job applications. A survey collects information about the user's professional interests. Resumes that are created and/or uploaded will be adjusted to the applicant's age. The user will go through a series of games that collect information to be used in applying for jobs. This architecture allows the system to access prestored resumes that were previously created in the gaming system with the most matching criteria that will automatically match to the employer's job descriptions and requirements allowing speed, accuracy, and better use of time.

In order to accomplish desired objectives, the system employs an associated software that begins with a survey to collect customized information per user. Next, a specialized predefined functional template is created and/or uploaded to generate the resume. To gamify the user's experience, an Avatar will be auto selected. Next the user begins game play. Game 1—STAR STAMP which allows users to rate job postings from 1-5 stars. Game 2—JOB INSPECTOR which inspects the job postings from STAR STAMP and matches keywords from selected user's resume with suggestions and minor adjustments to help get through the Application Tracking System (ATS). Finally, the user applies to the selected job post by playing Game 3—GET HIRED. Followed by Game 4—CIRCLE BACK Which is a ‘follow up’. Additional games shuffle through based on the user's customized survey answers. Additional games may include, as VOLUNTEER, SWITCH and STAND-OUT which are defined below. This software allows users to stand out above other applicants, therefore enhancing their ability to get selected for multiple job interviews and eventually getting hired.

The system provides a gamified architecture with associated software that helps job seekers find jobs to solve the mundane process of looking for work while making the job search fun, efficient, and easy. Furthermore, the system and software that stores resumes that are matched to job descriptions in a database with minimal input and effort from the user. The system can auto search available positions and rate it by the user such that the user can solely focus on their highest ratings, helping them get closer to their dream job by getting passed the algorithms put in place by the employers.

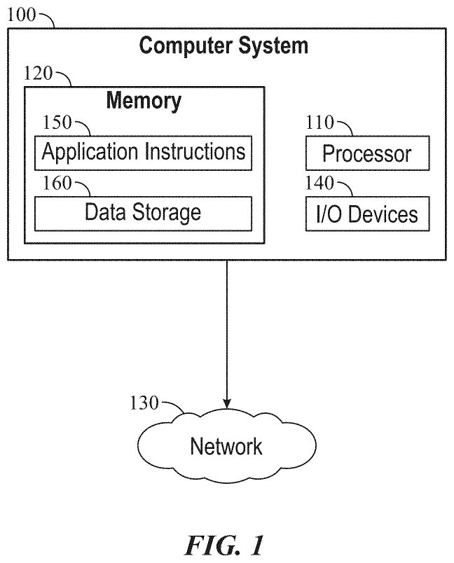

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile tablet device, a mobile audio or video player, a game console, a Global Positioning System (GPS) receiver, or a portable storage device (e.g., a universal serial bus (USB) flash drive). The system may also implement cloud-based storage.

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C #, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system is made up of various components. Using the user's age, the software will generate a resume by guiding the user through questions and examples of resumes or may allow the user to upload resumes. The software will scrutinize user's resume to the desired job post and match common phrases and/or keywords. The system then updates the user's resume to match the job post perfectly and store the resume for future similar job posts while the original resume remains intact. The user may apply and get through the ATS system in an efficient manner. These components are associated with one another in the following manner. The resume's file name (uploaded or created) will be named by the user's occupation of interest. The system will inspect the selected resume's name (occupation of interest) and match it to the job post's requirements and/or description. The system then intelligently suggests adjustments on the selected resume, allowing the user to seamlessly apply and feel confident with every job application submitted. The associated computer process is made up of the following executable steps, all of which are required in all versions: (1) User's age is input and analyzed, (2) create or upload resume into the system's format. (3) the system scans for similarities with job posts and their selected resume, (4) update the resume as suggested, and (5) apply for job with personalized resume created on step 4. (6) The system then stores updated resume while keeping the original intact.

The system may also have one or more of the following optional components: video resume capabilities, volunteering opportunities, drip campaigns, resume templates, options to drop off your resume, options for dropping off a video resume in person, and an assessment and/or aptitude test, which are features to boost the user's chances of getting an interview as well as a career change, if needed. Video resumes may help the employer and recruiter get a feel for who the applicant is. As an additional aspect from reading a resume the employer/recruiter can see the applicant's highlights in 90 seconds or less (or similar time period), directly from the applicant. Video resumes may be fun and may provide a more personal touch to the traditional hiring process. Volunteering gives the applicant the opportunity to get involved and give back to the community, other users, employers, etc. This helps in expanding the user's network as well as mentally help the user maintain a positive attitude while being unemployed. Furthermore, the associated computerized process may also have one or more of the following optional executable steps: The personality DISC assessment and aptitude test has been used for decades throughout employment opportunities. The DISC and aptitude assessment is a great optional feature for users who want to change their careers and/or first-time job seekers who don't know where to start by identifying their strengths and weaknesses. Various forms of drip campaigns in the system will auto create email drafts follow ups on specific job posts the user selects as interest. The system offers templates to choose from and the option to personalize, allowing the user to be on top of their application history. Dropping off a video resume and/or resume in-person has also shown a boost in applicants who get hired. The system will auto detect (if available) the job post location and suggest dropping off your video resume or paper resume in person. The system will sync to your calendar or any digital calendar service and allow the user to schedule a day to drop off the video/paper resume. This takes all the guess work out of the process and holds you accountable

The system permits any number of resumes to be uploaded per user and may include various price packages chosen by each user. Each resume may be customized based on the particular job they are applying for, the particular industry of the job, etc. Resume creation may be based on the user's age which are reflected in resume design templates. Each resume's file name will be changed to the user's occupation or position of interest. Along with the resume upload and/or creation process, location services may be available to ensure job seekers and employers are suitably matched by location. This service is also available per resume to assist users who are relocating beyond county, state and national borders. In addition to the resume, the user can also create a video resume with easy-to-use editing and other video sampling assistance which are integrated within the system as an upgrade. The system may follow up with a brief survey of questions to better optimize the job-hunting and gaming experience. The system will also include its own email interface to help better organize marketing and various drip campaigns and its corresponding analytics.

These components are combined together to create an architecture for the gaming system that has a plurality of games which may include: Star Stamp, Job Inspector, GET HIRED, Circle Back, Volunteer, Switch and its bonus game: ‘Stand Out’. It should further be noted that: the games just mentioned have direct correlation between game play, survey questions and the resume such that the games direct the user through resume generation, follow-up, interview preparation, job hunting, and other associated processes in the employment process.

In one example, in the same way people give star ratings to all sorts of companies and products online; STAR STAMP will allow the user to rate resume related job posts of interest from 1 to 5 stars, while being timed. The star ratings are as follows: 1 Star=‘Fair’ (“I can make this work’); 2 Stars=‘Good’ (“Not Bad”); 3 Stars=‘Better’ (“This will work for a while); 4 Stars=‘Best’ (“Just what I needed”); 5 Stars=‘Perfect’ (“Dream Job”). Star Stamp ratings will have a direct connection with the following game, ‘Job Inspector’. Job Inspector is vetting for similarities between the resume and the job description Star Stamped. The Job Inspector inspects the jobs stamped with 5 or 4 stars. At the same time, Job Inspector will allow the user to edit and match their resume with a healthy balance of rich highlighted suggested key words or phrases from the employer's job description allowing the user to have higher chances of getting through the ATS system with a natural flowing resume.

With Star Stamp and Job Inspector in communication with one another, the user now has the access to play GET HIRED. GET HIRED is a game which includes the user applying to the job post with the companion resume created with Job Inspector. In some cases, there may be additional steps and/or questions required by the employer. GET HIRED will prompt the user to answer the additional questions. The companion resume created with Job Inspector gets stored internally without replacing its original Resume creation. This feature allows Job Inspector to search through all internal resumes and select its most matched resume to the hiring post turning a daunting task into a desirable task. As a bonus, Job Inspector will use artificial intelligence to match consistent changes made on any resume and make suggestions on permanent resume revisions to speed up the job application submission process during GET HIRED.

To boost the user's chances of getting an interview and possibly getting the position they want, GET HIRED's next phase is Circle Back. Circle Back is as easy as a follow up email except it is automated with the option of a drip campaign. Circle Back will auto-select a follow-up date or allow the user to select a custom date. The options will include email draft templates the user can choose from and edit with the associated resume attached and/or Video Resume of its original job post application. It also includes the option to set up a drip campaign associated with each follow up. To enhance the gaming experience, Circle Back will also auto search company's directory on social media or networking platforms along with a search for the company's address (if the company is disclosed on the job post.) This feature permits the user to not only follow-up via email, but also reach the employer on these well-known social media or networking platforms for a possible phone call and/or text. Finding the company's address favors the user to drop their video resume and/or resume in-person.

Based on the user's answers affiliated with the brief survey questions in the beginning of the user creation process, the user may have the option to play one of the additional games: Volunteer which allows the user to select various volunteering categories. Volunteering can open the doors to new work and at the same time lift the user's spirits from being unemployed or looking for new work. Often, users may want to make a switch in career paths or employers which introduces us to our next game called Switch. Switch focuses on users who have an interest in changing their careers and would like their resume to reflect such a change. Switch gamified will correlate with the brief questionnaire in the beginning of their account creation and prompt the user to take a DISC assessment as well as a career aptitude test. This will allow the users to then unlock access to our career changing coaches. Coaches may work with the users and give tips and suggestions on how to make the necessary changes on their resume. Stand Out will automatically smart search the user's resumes and applications history and suggest companies that are NOT hiring but have previously hired or have had similar positions that are of interest to the user. Stand Out will provide tips and recommendations for ways to make an introduction as well as following into the gaming cycle of Circle Back. With respect to the software, in its most complete and preferred version, it is made up of the following executable steps: Entering general standard user information, allowing location services, or customizing location services per resume as well as miles radius, answering a brief set of questions, uploading multiple and/or create multiple resumes, the option to boost employment opportunities by uploading multiple and/or creating multiple video resumes.

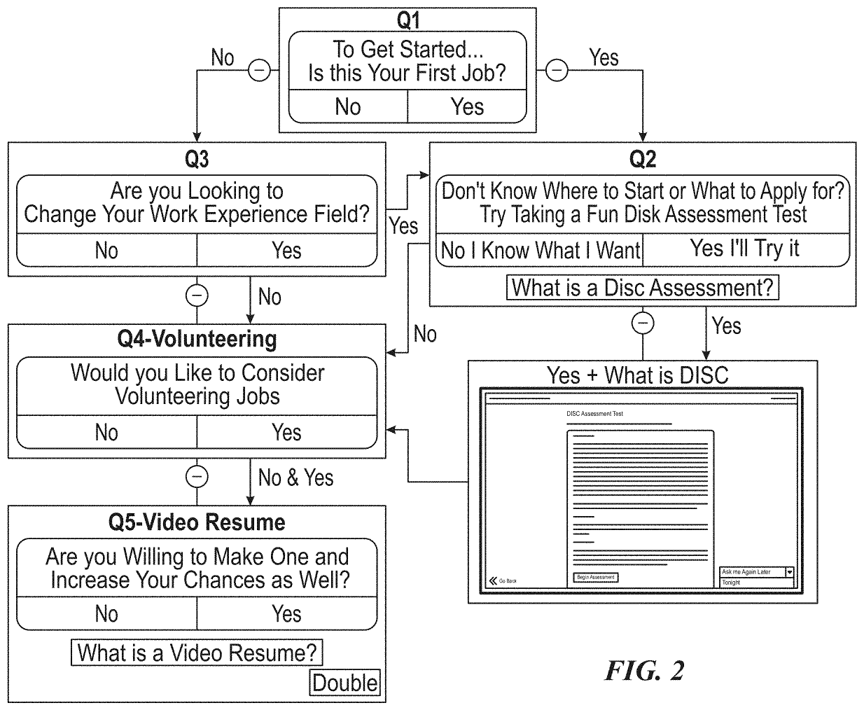

FIG. 2 illustrates a flowchart of the questions provided to the user, specifically when they first sign up for the system. For a better user experience, part of the systems process is getting to know the user and their best interest for their job-hunting journey. The brief questionnaire helps better “customize” the flow and interest for the user for their ultimate results. Question 1 (also known as Q1) asks if this is the user's first job. This will determine which resume creation will be best for the user. Followed by Question 2 or 3 (Q2/Q3) Is the user looking to change their work experience into a new career? Whether it is their first job, or if they'd like to change careers in their work history, they will be asked if they'd like to take a DISC assessment to help better identify what they are most skilled at. Taking the assessment is optional and will help the system stay focused on the user's strengths. Question 4 (Q4) is to help the user get out and get involved by volunteering. If the user shows interest in volunteer work, their gaming session will unlock the ‘Volunteer’ game. Question 5 (Q5) is exposing the user to the use of video resumes. Every answer the user gives can be changed in their Settings.

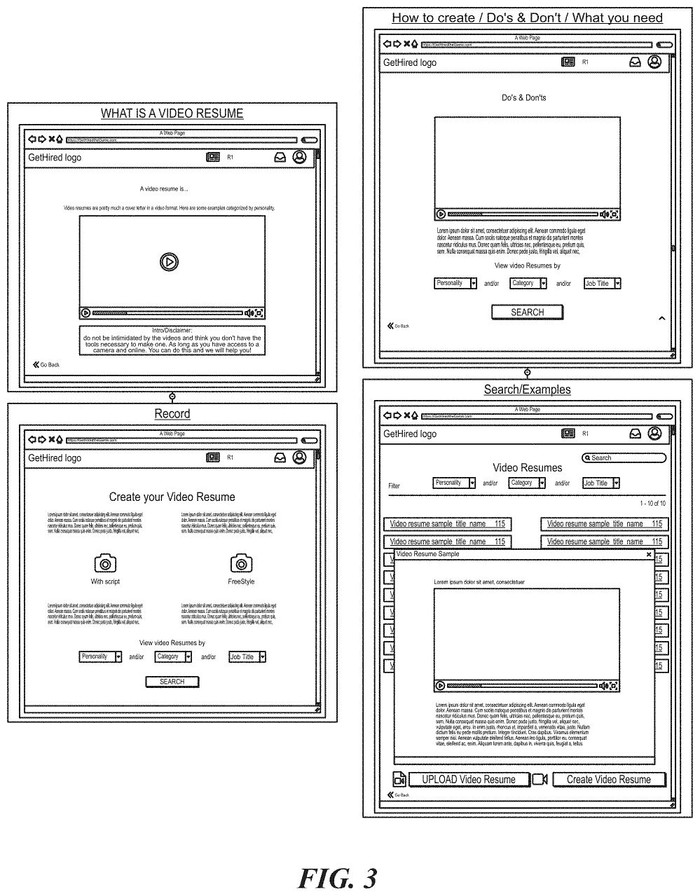

FIG. 3 illustrates screenshots of the video resume interface. If the user decides to create or view video resumes, they will be directed to the video resume window's brief explanation of what video resumes are, how they are beneficial, and how easy they are to make with the system. Tips, suggestions, what you need, do's & don'ts, will all be provided for the user. The user can also view videos from real people from the library. Filtering options from, personality, job title and/or job category, the user can view examples to get inspired. As video resumes are created, more will be added to the library with the user's permission. Recording will be available in the software with Basic, easy to use editing such as, changing your background, adding music, text input in video, clip, and motion features. The user will have the option to type their script and read it as its recording or freestyle their video. The video resumes will be saved in the user's profile. The file name must be saved as the user's occupation of Interest. Multiple video resumes can be saved by changing the file's name to another occupation. With editing made easy, the user can quickly record different words and replace it on their videos to have a unique video resume per job occupation of interest.

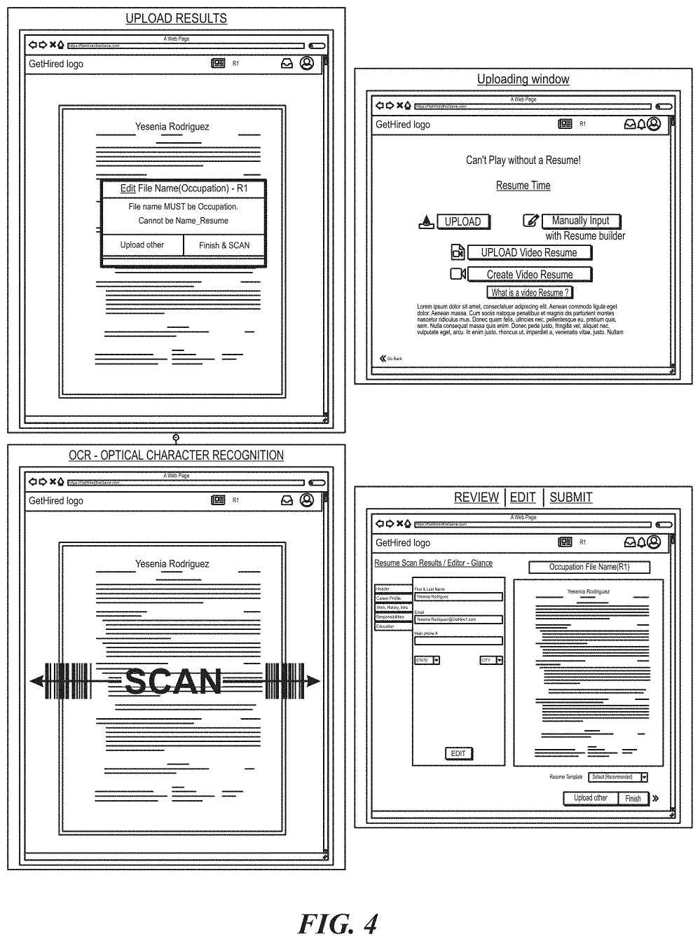

FIG. 4 illustrates a flowchart of the resume upload options. Uploading features allow options from the user's cloud, desktop, phone, drive, and other relatable file storage and may accept various file formats. The uploading process flows as follows: once uploaded, the file name is changed to the user's occupation of interest. The resume being uploaded should match the occupation used to name the file for best results. If the user's resume is generic, the system will provide tips and suggestions of occupation names to help user rename the uploaded file. A non-recognizable occupation will not allow user to save the occupation to their profile. Once the user's file is renamed, the system will use OCR (Optical Character Recognition) on the resume uploaded and input into the standard functional resume template according to the user's internal category created during the account creation process. The user will then review the format and select any of the following options: Edit, Upload Other, Duplicate, Change Template or Finish. If the user selects ‘FINISH’ and only has one resume, the user will be alerted as a suggestion to upload more than one resume. If user only has one resume, the system will suggest duplicating that one resume and change the file name to other occupations or similar occupation names. The system will always provide a list of similar occupation names to help user with renaming their files. The user may also select all suggested names in an occupation category. This is important and the core info needed to allow the system's gaming to function. The system will auto search job post of interest using the file name on user's resumes. With this function, the user does not need to manually search for jobs available and constantly change their job search. The system will have some resume templates available for user to choose from to help fit their personality/career if needed. If ‘Duplicate’ or ‘Upload Other’ is selected, the steps on this paragraph will be repeated. When ‘EDIT’ is selected, the user will be transferred to the resume builder window.

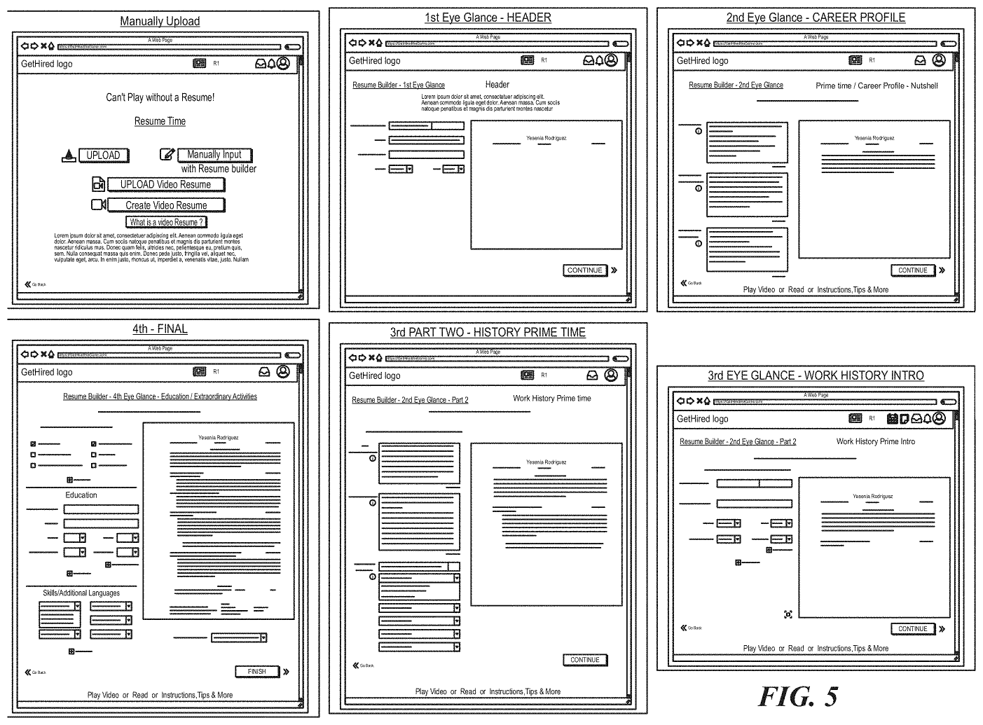

FIG. 5 illustrates a flowchart of the resume builder. A specific resume template will be auto selected based on the user's age category input during the creation process. The resume builder will be split into five parts of fill in the blanks to avoid any user getting stuck or frustrated in creating their resume. The five parts are broken down as follows: 1st Eye Glance: Header; 2nd Eye Glance: Career Profile Nutshell; 3rd Eye Glance Part 1: Work History Intro; 3rd Eye Glance Part 2: Work History Prime Time; 4th Eye Glance: Education/Extracurricular Activities. User categories templates uniquely differ as follows: [Teenagers: 14-19 years old: Full date input for Education and beginner Work History]; [Young Adult: 20's & Prime-Timer: 30's: Year start & finish input for Work History & year completion in Education]; [Maturing Adult: 40's & Golden 50+: No input for Education date or year of completion, year start and finish for employment maxes out in 10 years]. This is to avoid age discrimination while reading a resume. As the user “Fills in the Blanks” they will see their resume auto generate with their input. In some cases, job descriptions will be automated when a job title or career category are entered in 3rd Eye Glance Part 1 & 2. Upon entering the 4th Eye Glance—the user will see a drop-down menu for skills. Skills will be auto generated as selections based on the user's job title and/or career of focus. The user will also be able to add their own skills. Instructions and tips along with notes will be available for the user in a video format or readable format. Upon finishing to build their resume, the user can select from different resume templates and pick the template theme that is best suitable for them. The resume will be saved with the occupation as the file name. The user will also have the option to download the resume into their drive, PDF, word formats and similar programs. The user will also have the option to duplicate the resume and save it under a different occupation file name.

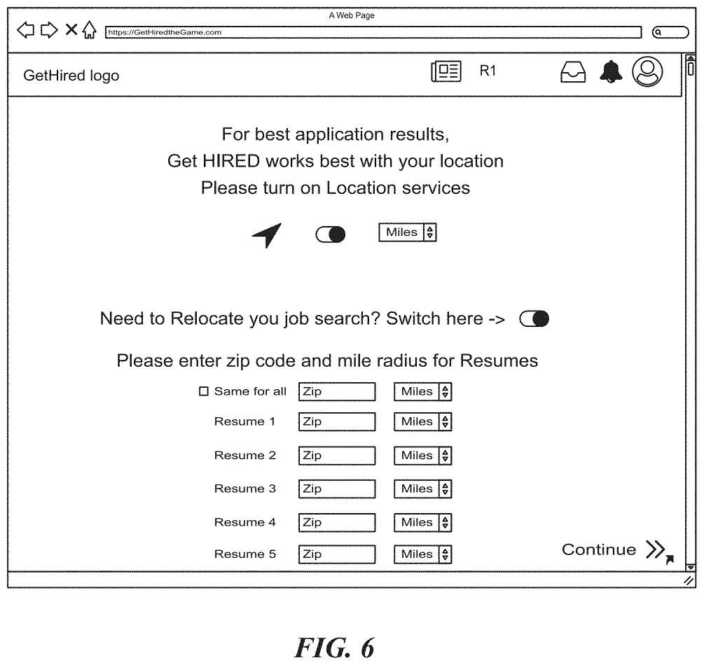

FIG. 6 illustrates the location services platform. Location services are pre-set to better help expand the user's job hunt. Since GET HIRED works with the resume file name as the job occupation, presetting the mile radius is important. In some cases, the user might need to relocate. With GET HIRED, the user will have the option to set a destination for each job occupation/resume. This allows users to job hunt outside of their region with little to no effort on their end. This setting can be changed by accessing the settings menu.

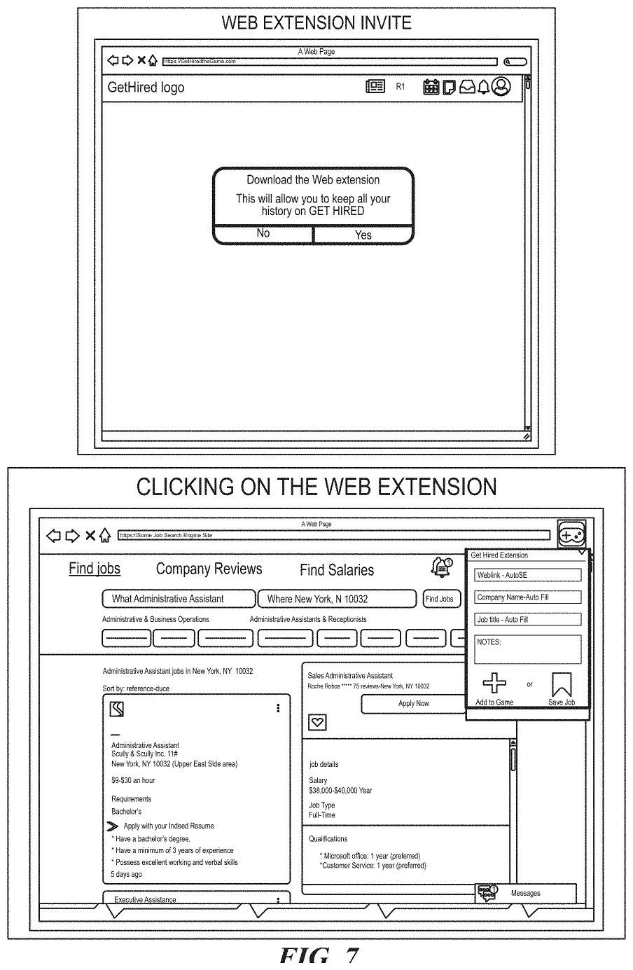

FIG. 7 illustrates a screenshot of the web extension associated with the system. A web extension is recommended to allow users to keep their entire job hunt in one location. The web extension will be downloaded to their web browser given permission. It will detect when the web browser is in a job-hunting site and highlight itself to prompt the user to click and apply with GET HIRED. The user can still click and access the extension if it does not recognize a job-hunting site. Its input will be auto filled with the website link, the company name and/or job title. The user will have the option to add notes and select ‘Add to Game’ or ‘Save Job’ to submit the job post to the system. Selecting, ‘Add to Game’ will be auto entered into the game ‘Star Stamp’ and will show as the users first option to stamp upon entering the game. Selecting, ‘Save Job’ will be auto entered into ‘Stamp Later’. The jobs ‘Saved’ also known as ‘Stamp Later’ will be accessible via the user's dashboard and will shuffle through the game Star Stamp.

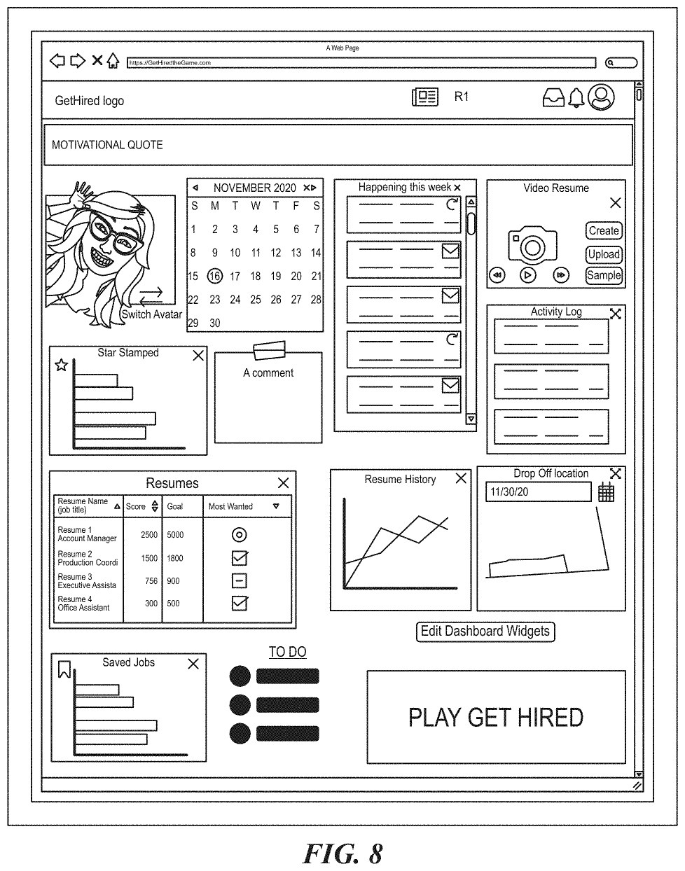

FIG. 8 illustrates a screenshot of the dashboard. The dashboard in GET HIRED is managed by customizable widgets. Seeing the board from top to bottom, we first see a motivational quote. The GET HIRED logo on the top left will always redirect the user back to this dashboard. Top far right: the user's photo will be displayed and a drop-down menu to access Settings, Help, Share GET HIRED or Log out, followed by the user's avatar. A standard avatar will be auto selected for male or female users as per account creation. The user can select the avatar and switch to another character of their choice. Below the avatar is a widget for the game ‘Star Stamp’ this will allow the user to see which jobs have been stamped from 1 to 5 stars. Details correlating the stamp can be viewed when the user clicks into the Star Stamp widget. The user can also be redirected to play the game Star Stamp. The next widget to follow is a ‘Resumes’ widget. The user can rearrange their resumes from their most wanted position to their least. This order will correlate with the resume's score focusing more on their most wanted by giving them the highest goal score and so on. Another widget that correlates with the game Star Stamp is the ‘Saved Job’ widget. This widget shows cases all the jobs posts the user has marked as ‘Stamp Later’. A calendar widget will show scheduled interviews and/or video/resume drop offs. The user can click into the calendar widget and schedule other reminders and sync to their personal phone/computer calendar or third-party calendar API's. A comment and/or note widget for the user to click into and input. There is also a widget of a ‘Task/To Do’ list for the user to organize themselves as they see fit. ‘Happening This Week’ widget will showcase all automated outgoing emails and or reminders. Automated emails are created using the drip campaign feature in the Circle Back widget for resume history which shows the user the analytics of their resume. These analytics include positions/companies the resume was sent out to, details of companies, and the search engine of where the job post was originally posted, when they applied, and time they applied. This is followed by a video resume widget to help inspire and remind the user to create, upload and/or view samples of video resumes. Below the video resume is the user's Activity Log. This will give the user easy access to track and or see details of their activity. Clicking into the activity widget, the user will see in depth details of their activity. The drop off locations' widget is synced with navigation. It will sync with the calendar and show case the scheduled location the user creates while playing ‘Circle Back’ clicking into the widget redirects the user to the navigation app of their choice. The user has the access to edit the dashboard widgets and add other widgets not shown on the wireframe. These may include weather, related blogs, their personal email, trending topic of the week in GET HIRED's platform, updates with job search engine sites, access to their social media profiles, and social post from other users. Lastly, a button is provided to enter the game of GET HIRED. Accessing the game will shuffle through the games once its original order has been played and has enough stored data to shuffle through.

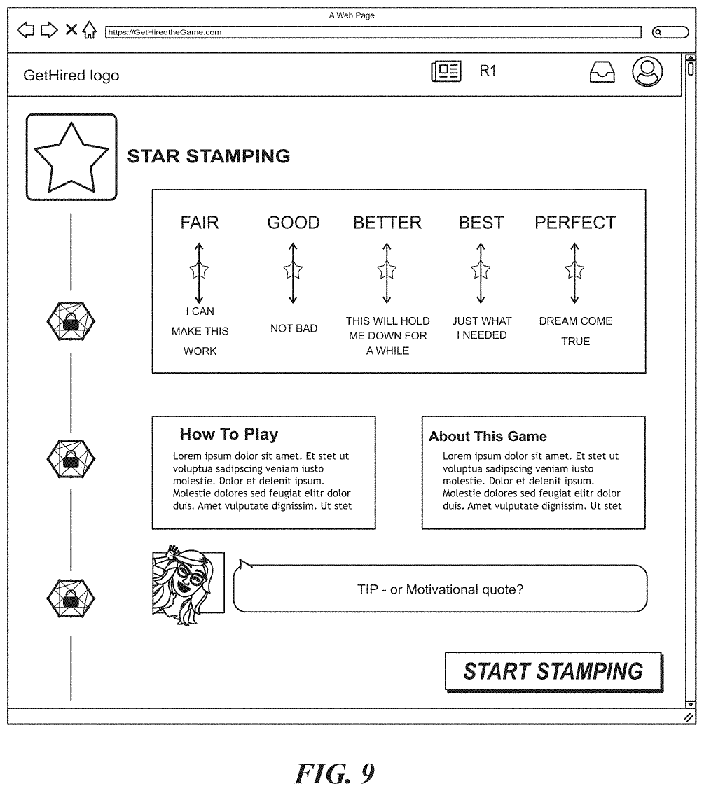

FIG. 9 illustrates a screenshot of the Star Stamp interface. Star Stamp's game logo magnifies to show that it is active and unlocked. The user will also see there are upcoming games as locked. The main game window shows what the stars mean for the user to understand how to stamp each job post. It also shows quick instructions on how to play as well as the ‘about this game’ which shows the benefits of the game. It is followed by the avatar showing some tips or a motivational quote to keep the user enticed. For first-time players, the game will begin with a small practice demo for the user to practice playing before its real run.

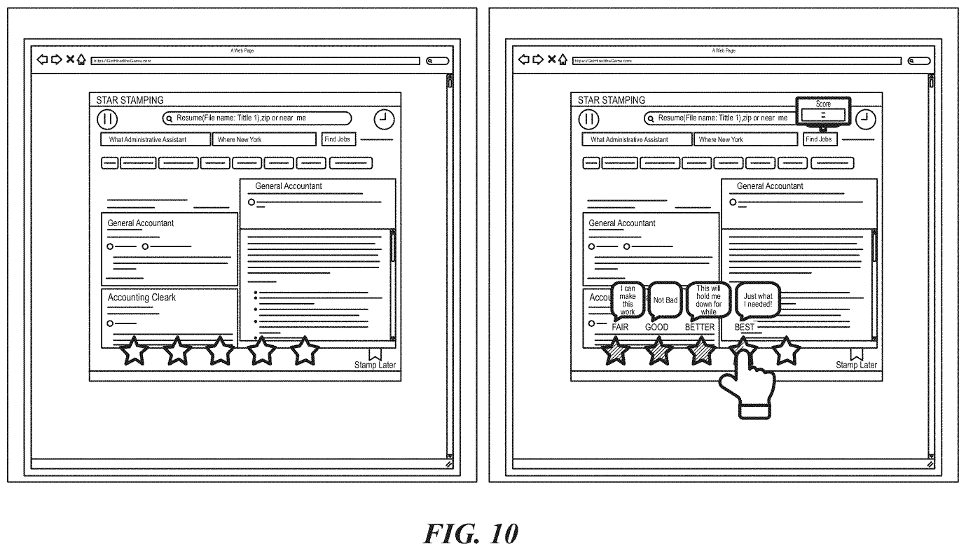

FIG. 10 illustrates a screenshot of the Star Ratings interface. Star Stamp will shuffle through different job search engine layering on top of various job post search engines, allowing the user to view and browse through job positions without necessarily applying. A timer on the top right will be displayed for the user to be aware of their game time limit as well as a pause button on the top left. The timer helps keep the user moving forward to reach the applying process in the following games, while making it fun. As the user hovers over the actual stars to stamp on as shown on the figure, they will see the stars fill as well as what the stars means. The user will also have an option to Stamp Later which equals to ‘saving a job post as favorite’ (located near the bottom right). The Stamp Later job post will shuffle and reappear when the user logs in to play on a different day or hours later. It will continue to reappear until it is stamped, or the post is no longer available. The user will also see their score generating as they stamp job posts of their interest. The search engine filtering options will be available to user if they want to change the standard search. The search engine on the job post will be auto filled with the user's resume's file name (occupation) and will search with the zip code associated with that resume or use their location services. The mile radius will also be auto filled with a standard 25 miles or auto filled to the user's preferences.

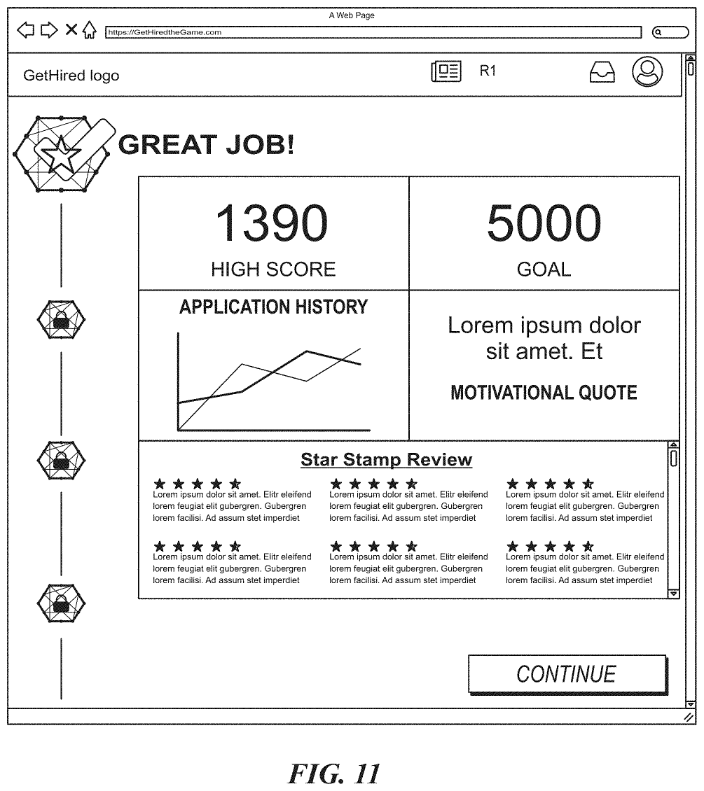

FIG. 11 illustrates a screenshot of the Star Stamp completion interface. Once complete, the game's icon will be marked as completed. The user will also see the following game unlock as they complete a game. The completion page shows the user's current score in the game next to their game goal. The game goal is an auto feature that will increase as user reaches their goal. It also shows the scoring history in a line graph to allow user to see a quick review of their scoring progress. The user will see a motivational quote or affirmation to keep them enticed. To wrap up the game you will also see a review of the stars stamped during the gaming session. Since Star Stamping is not allowing the user to apply to the job rather than rate it, the user is prompt with a Continue button.

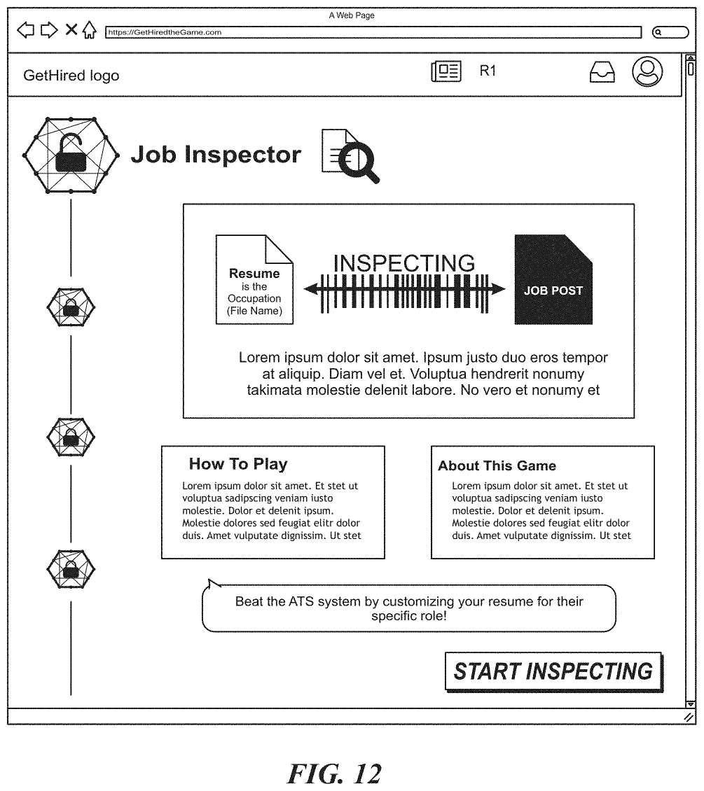

FIG. 12 illustrates a screenshot of the Job Inspector interface. The main game window shows imagery (e.g., a GIF, TIF, PNG, BMP, or JPEG) showing how Job Inspector quickly inspects the users resumes with the associated job post stamped from the previous game. It also shows quick instructions on how to play as well as the ‘about this game’ which shows the benefits of this game. It is followed by the avatar showing some tips or a motivational quote to keep the user enticed. For first time players the game will begin with a small practice demo for the user to practice playing before playing the game.

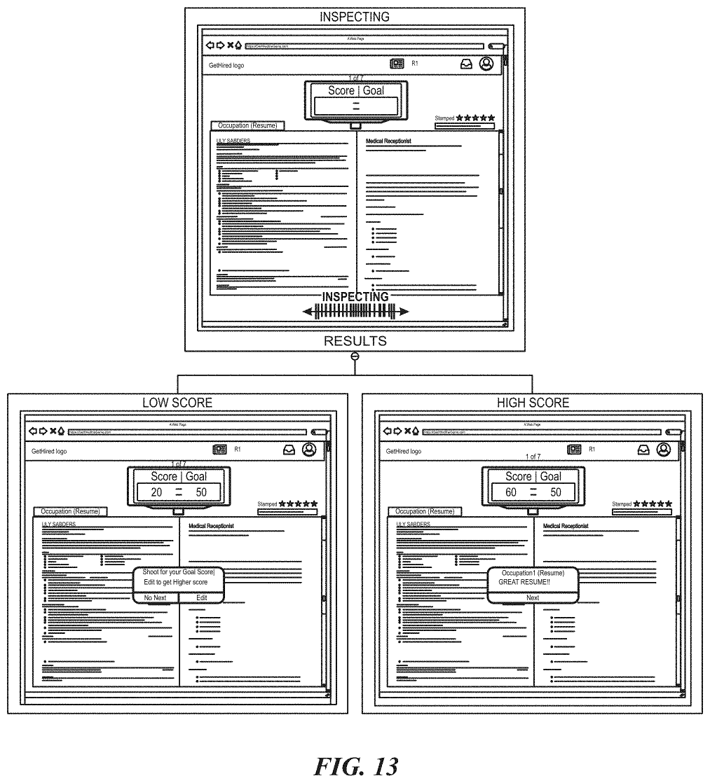

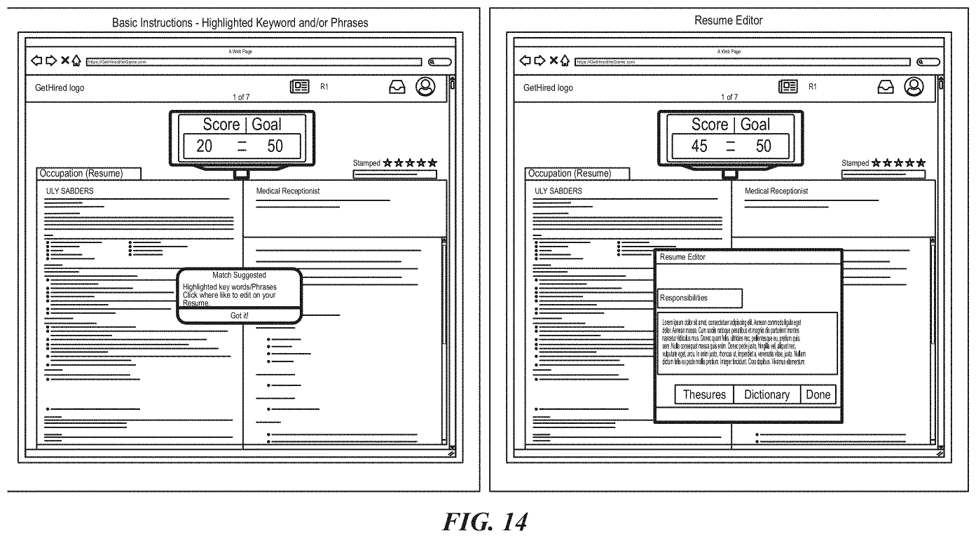

FIGS. 13 and 14 illustrates the OCR component of the Job Inspector and Shows the resume and job post used in Star Stamp with the stamping rating. It also shows the job post search engine info. Job Inspector will focus on the job posting stamped 4 or 5 stars. If the user has no data in the 4 or 5 stars rating it will use whatever rating is highest. The resume and its associated job post will be viewed side to side. Job Inspector will use OCR to inspect the resume with the associated job post and determine a score. Its score will be determined if the user's resume has enough key word or phrases, word groups skipping over common words (like, the, and). It will prompt the user with an alert if their score is too low with the option to edit and make some more matches. It will also show an alert if the resume has enough matches prompting them to inspect another job post rating.

The results in Job Inspector's scoring is as follows: The less changes, the higher the score. The more changes, the lower the score. Scoring will define how well the user's resume's is matched to get through the Application Tracking System (ATS). A low score will result in suggesting the user makes changes. The changes made to the resume will not replace its original resume creation. Any changes to the resume in Job Inspector's resume editor will be stored internally with a code (example: Medical receptionist 1, 2, 3 etc.). The Job Inspector will inspect the resume using OCR and highlight on the job post key words, key phrases, word groups, etc. with options to copy and paste into its associated resume along with suggestions and tips. The user will be able to click where they would like to make the changes on their resume and the ‘Resume Editor Window’ will appear. Other options in the resume editor include the thesaurus and dictionary as well as the paste button. The more suggested words and key phrases that match, the higher the score with the option to submit as is if user decides. The user will be notified when the target score is reached prompting them to inspect another stamped job post. As the user makes matches to the resume in Job Inspector's resume editor the updated resume gets stored internally. There is no limit to resume's stored internally except there may be a possible charge for a certain number of resumes. The Job Inspector will search through the associated internal resumes to speed up the game. If the resume most used is an internal resume vs its original resume, Job Inspector will suggest for the user to replace their original resume with the most used internal resume along with easy-to-read data analytics chart (e.g., Resume Medical Receptionist 10 has been used for most of your applications in this category. This is a strong resume. We suggest you replace your original with this one).

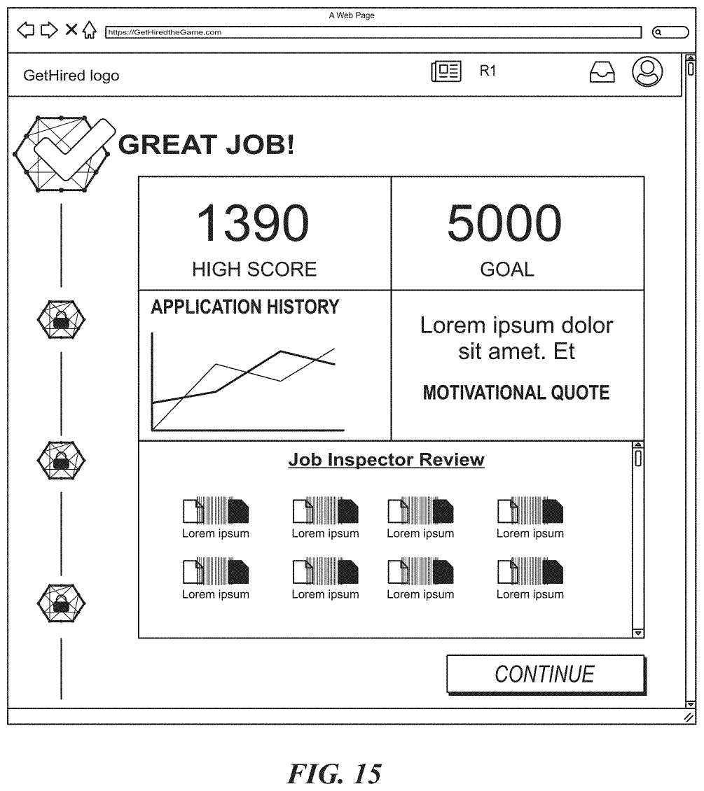

FIG. 15 illustrates a screenshot of the Job Inspector completion interface. The completion page shows the user's current score next to the user's goal score. The game goal is an auto feature that will increase as the user reaches its goal. It also shows the scoring history in a line graph to allow user to see a quick review of their scoring progress. The user will see a motivational quote or affirmation along with their fun avatar to keep them enticed. To wrap up the game the user will also see a review of the jobs inspected resumes along with the job posts during their gaming session. Since the Job Inspector along with its previous game, (Star Stamp) does not allow the user to apply to the job rather than preparing the user to have the perfect resume to apply, the user is prompted with a Continue button to follow suit on.

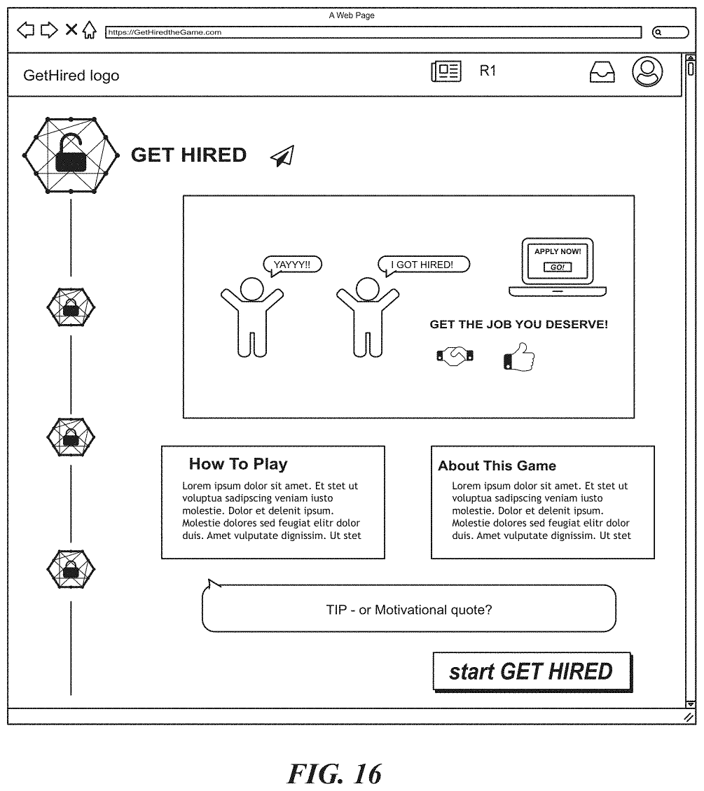

FIG. 16 illustrates a screenshot of the “GET HIRED” introduction interface. Following the pattern of the introduction to the previous games, the main game window shows a gif showing how GET HIRED, the game lets the user apply with their perfect resume. It also shows quick instructions on how to play as well as the ‘about this game’ which shows the benefits of this game. It is followed by the avatar showing some tips or a motivational quote to keep the user enticed. It shows a large START button to get into the game. For first-time players, the game will begin with a small practice demo for the user to practice playing before playing the game.

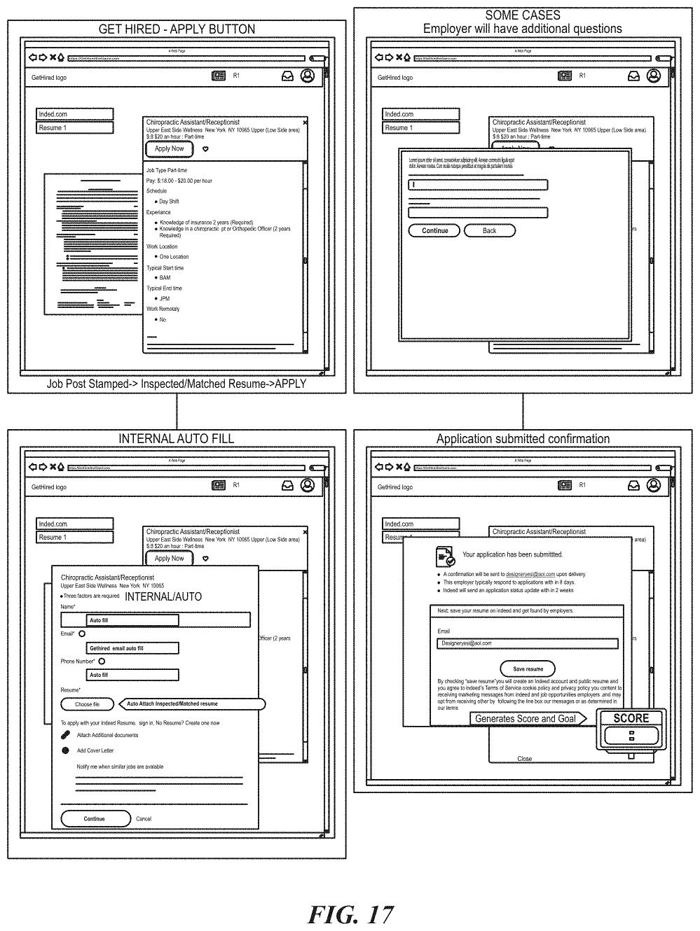

FIG. 17 illustrates screenshots of the application interface. First the user will see the results of all the previous games. They will see their resume along with its associated job post viewing from side to side. For viewing purposes only, they will also see its associated Star Stamp rating, the internal resume's name along with the job post original website as shown on the above figure (top left). The user will be prompt to press the job post's “APPLY NOW” button. The system will auto fill and auto attach all the user's information and its associated matched resume (left bottom figure). In some cases, the user will have the option to submit a cover letter in which the system will have a pre template associated using a smart set up for the user to easily submit. In some other cases as shown in the top right figure, the employer will request additional information from the user in the form of questions for the user to answer. The system will prompt the user to fill all required information from the employer. Some employers can request up to 10 questions depending on the career. If the user is having a hard time answering the required questions, GET HIRED will have its avatar pop up in cases like this to help keep the user enticed. To follow suit, after the application has been submitted, the user will have the option to attach a private note for themselves if desired, while GET HIRED auto logs in the user's profile/dashboard all details associated with the job post and its associated resume.

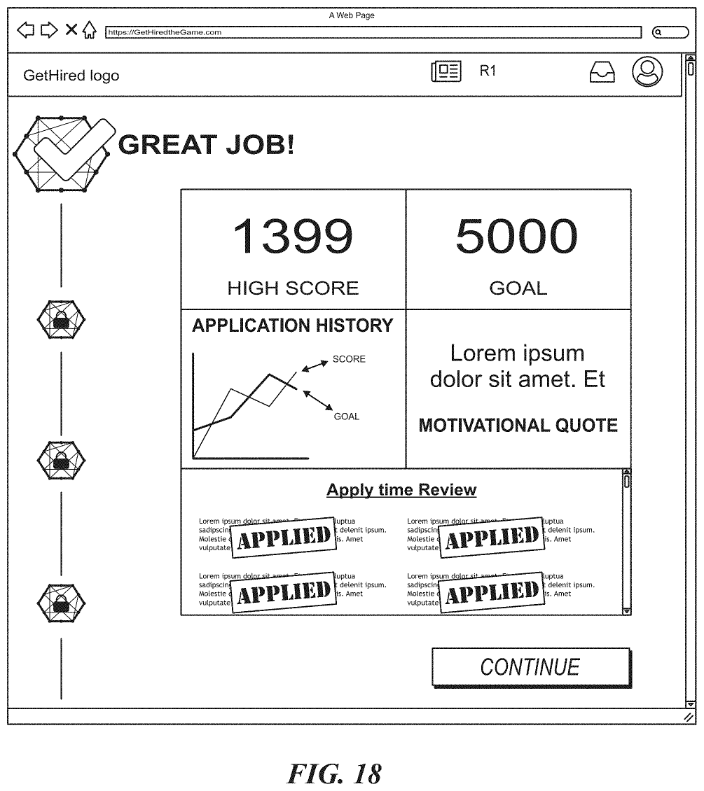

FIG. 18 illustrates a screenshot of the resume completion interface. The completion page shows the user's current score next to the user's goal score. The game goal is an auto feature that will increase as the user reaches its goal. It also shows the scoring history in a line graph to allow user to see a quick review of their scoring progress. The user will see a motivational quote or affirmation along with their fun avatar to keep them enticed. To wrap up the game the user will also see a review of the jobs applied during their gaming session in GET HIRED.

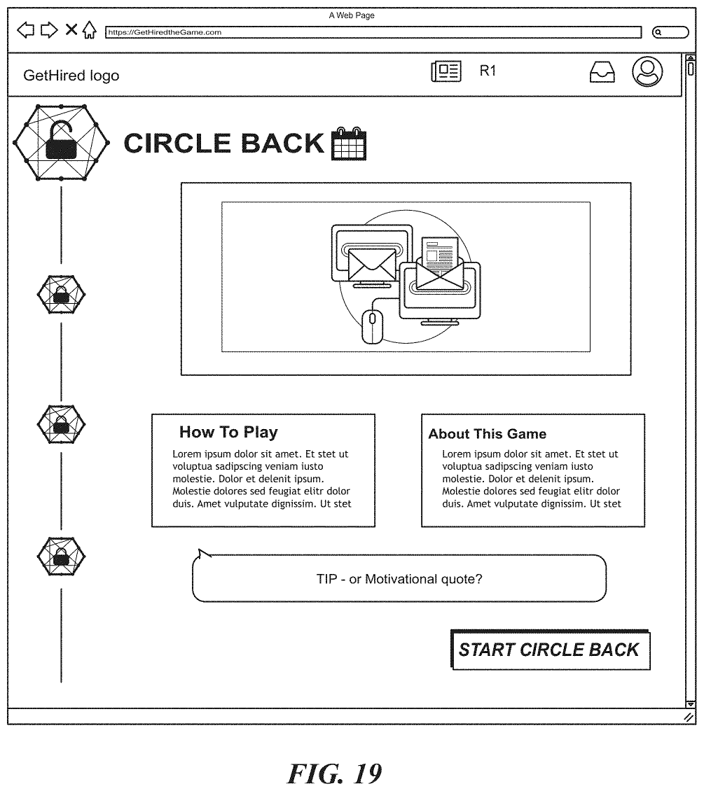

FIG. 19 illustrates a screenshot of the Circle Back interface. Circle Back allows the user to follow up with employers to which they have submitted a resume. The game's logo is magnified to show that it is active and unlocked. Following the pattern of the introduction to the previous games, the main game window shows imagery showing how Circle Back follows up. It also shows quick instructions on how to play as well as the ‘about this game’ which shows the benefits of this game. It is followed by the avatar showing some tips or a motivational quote to keep the user enticed. It shows a large START button to get into the game. For first time players the game will begin with a small practice demo for the user to practice playing before playing the game.

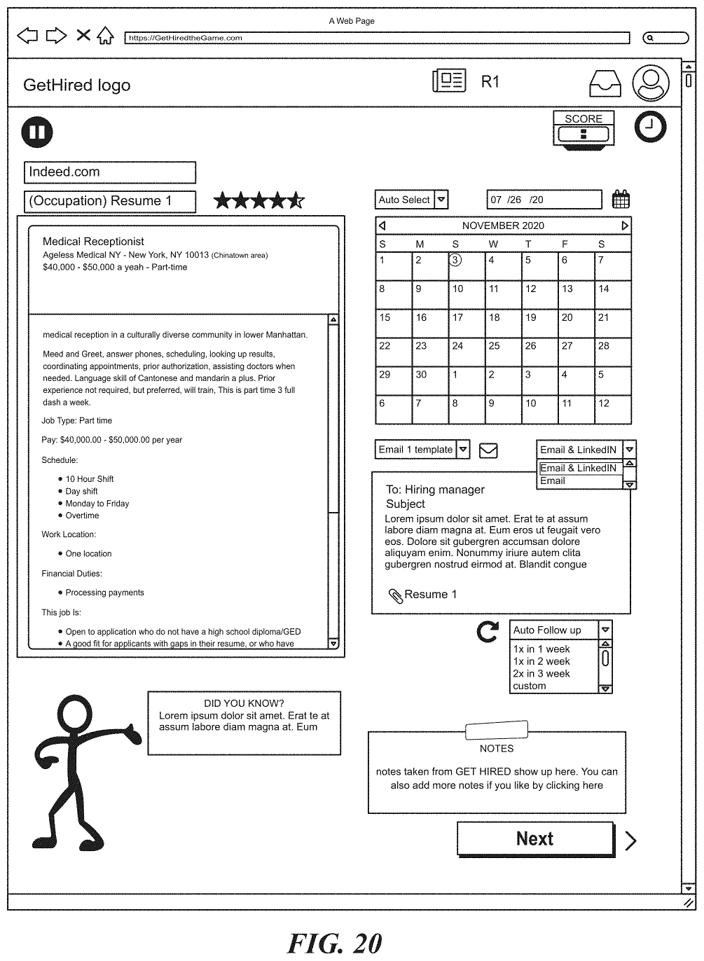

FIG. 20 illustrates a screenshot of the main interface. A timer on the top right will be displayed for the user to be aware of their game time limit as well as a pause button on the top left. The pause button will give the user the options to resume game, view ‘how to play’, ‘about this game’ and exit game. The game score is viewed near the top right next to the timer. Its scoring will be determined based on how many ‘follow ups’ they schedule. For viewing purposes, one of the job applications the user applied to while playing GET HIRED will be present. Along with viewing, the original job post search engine along with the Star Stamp rating. Under the job post the avatar will show some tips or suggestions. Ex: “Did you know” (see figure left bottom). To the right of the figure is where the user will be able to edit and play Circle Back. A Date will be auto selected a week from when the application was sent. The user will have the option to change this date to their liking. Also automated, are email templates along with the associated resume and/or Video Resume attached. The user will have 5 options to choose from the email templates with the option to add their own touch to it and replace the original template. If Circle Back's internal research is successful next to the email template options, the user will have the option to select additional resources to send a follow up. Set up like a drip campaign Circle Back will auto select reoccurring follow ups. The reoccurring follow-ups will sync with GET HIRED's inbox feature OCR which is a feature GET HIRED's inbox uses to determine if a response is negative or positive. In some embodiments, an email forward feature may be utilized to forward communications to the user's personal inbox. If a response in the inbox is matched with a follow up created in Circle Back, it will automatically deactivate its future follow ups. The user will also have the option to add notes. The system prompts the user to follow suit by clicking NEXT to Circle Back to another application. Everything scheduled and its occurrence will be accessible to the user in their profile/dashboard as well as their inbox

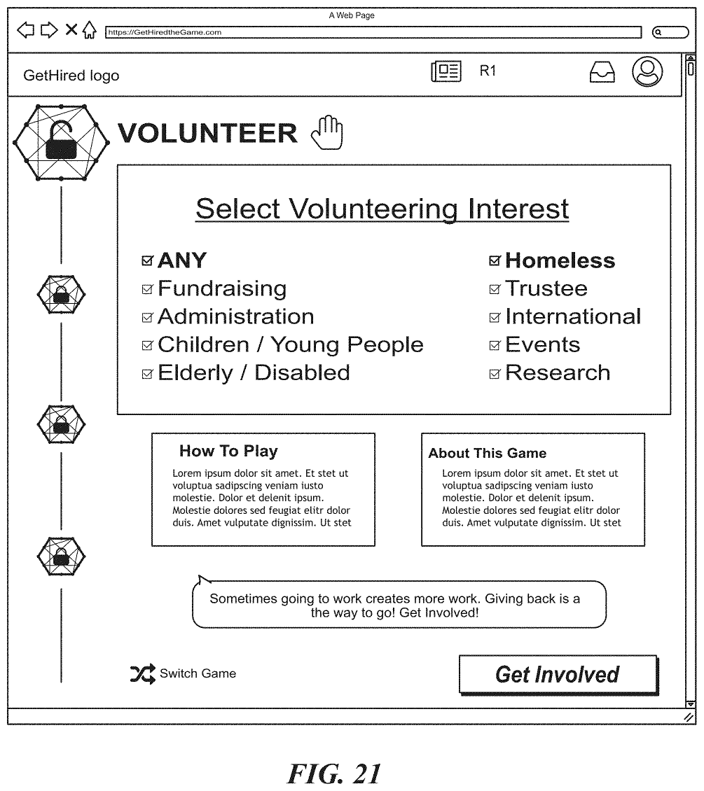

FIG. 21 illustrates a screenshot of the Volunteer interface. The Volunteering game will only be provided to users who selected interest in volunteering opportunities during their account creation process. In the game introduction window, a selection of volunteer interests would be automatically selected. The user can deselect any selection that is not of their interest. As new volunteering categories get added, the introduction page will be updated. Once the user selects ‘GET INVOLVED’ also known as ‘Play’, they will be redirected.

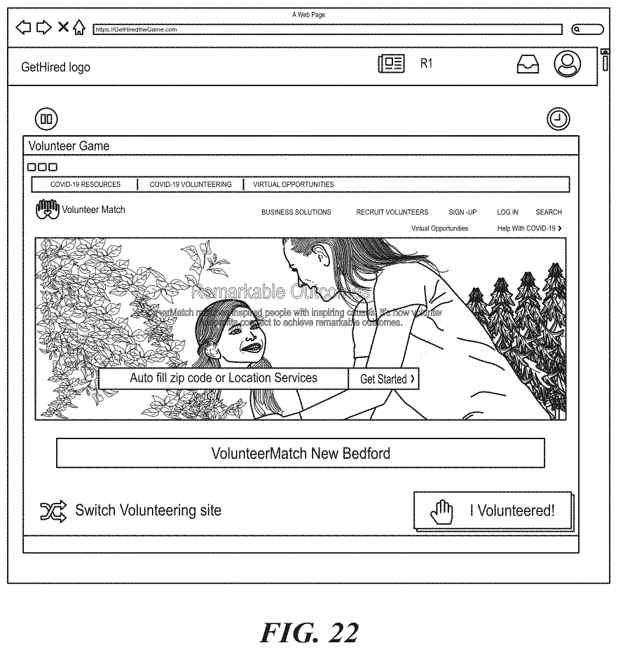

FIG. 22 illustrates a screenshot of the introduction to the volunteering system. The user's zip code or location will be automatically searched in the volunteering web sites. This Volunteering game is timed. A timer on the top right will be displayed for the user to be aware of their game time limit as well as a pause button on the top left. The pause button will allow the user to exit the game or view how to play. During the volunteering gaming session, the user will be able to browse the selected categories and apply to volunteering opportunities. The user can also select to switch volunteering websites if they do not see any opportunities of interest. After the user volunteers, they will be prompted to select ‘I Volunteered’ to receive scoring. The user will be prompted to apply to at least two volunteering opportunities as a minimum. If they reach the minimum of two before the timer runs out, an alert will advise the user that they have reached their goal and they can continue playing, and/or save a volunteering opportunity and/or move on to the next game. The system is designed to keep the user applying to jobs. In such, the user may be given a limit of how many times they may play a timed game within a specified period of time.

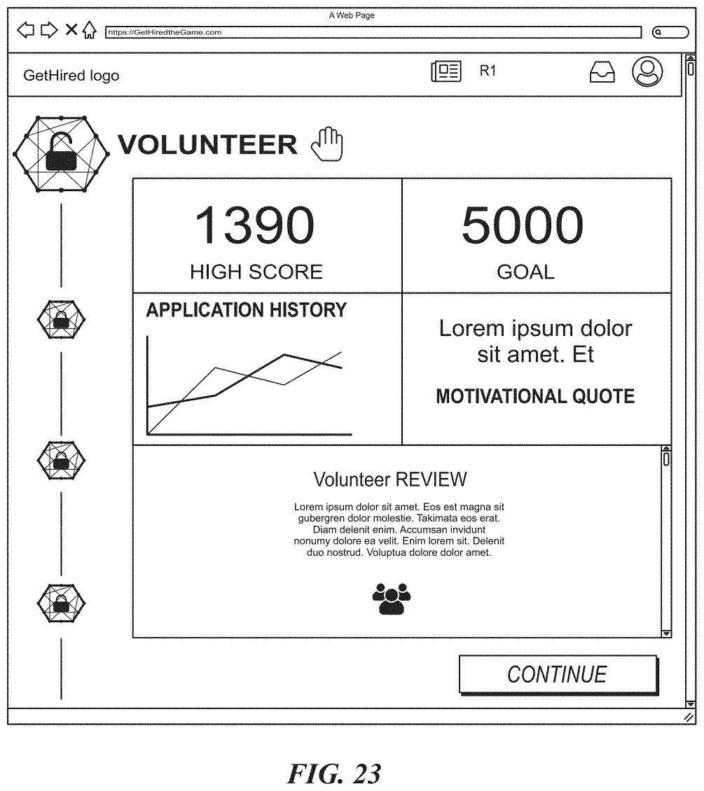

FIG. 23 illustrates a screenshot of the volunteering completion page. As all the previous games, it is followed with an ending page. The user will see their score with their goal. They will see their Volunteering history and a motivational quote to keep them inspired along with a brief review of their gaming session. The user can access volunteering opportunities saved or applied to by adding the volunteering widget on their dashboard.

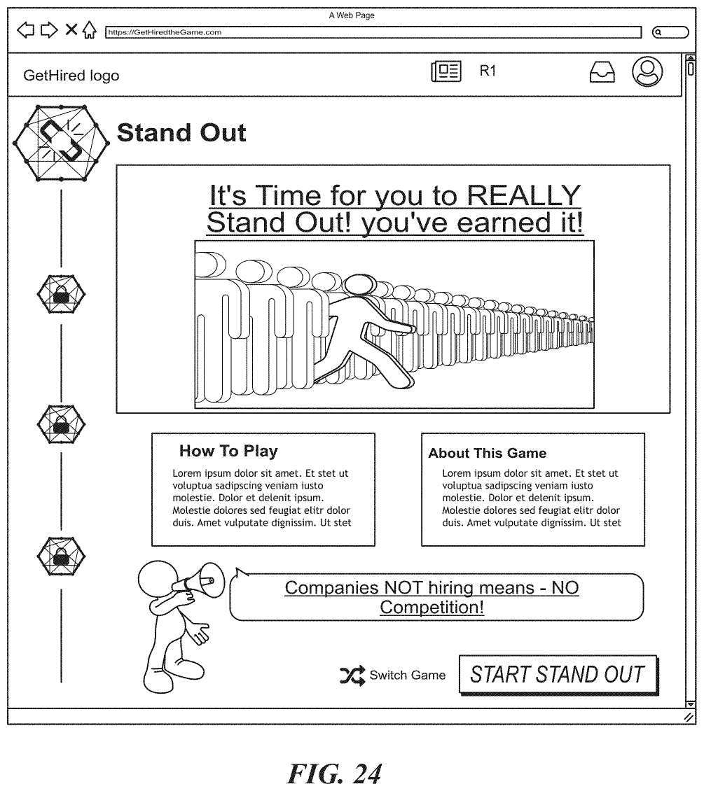

FIG. 24 illustrates a screenshot of the Stand Out interface. The bonus game ‘Stand Out’ gets unlocked when a user reaches their total goal score for all the games combined. Stand Out's functionality is a bit different then your general job post because it is focusing on companies that are not Hiring. Experts may work aggregate companies that have hired in the past or gathering companies that can use certain occupations and help build a large library of options for the users to reach out and make an introduction. Stand Out will use social media and well as job searching sites to find these companies and sync the positions or requirements to the user's resumes. Stand Out will have tips, video suggestions, help surveys to help the user make the perfect introduction with their resume and/or video resume. The user will have email templates that they can edit or send as is, as well as some address to possibly drop off their introduction in person. The user will also have the option to enter companies that they have always wanted to work for and GET HIRED will gather as much information as possible to get the user noticed. In closing this game, the user will be assigned a new score goal to continue playing and unlocking Stand Out again.

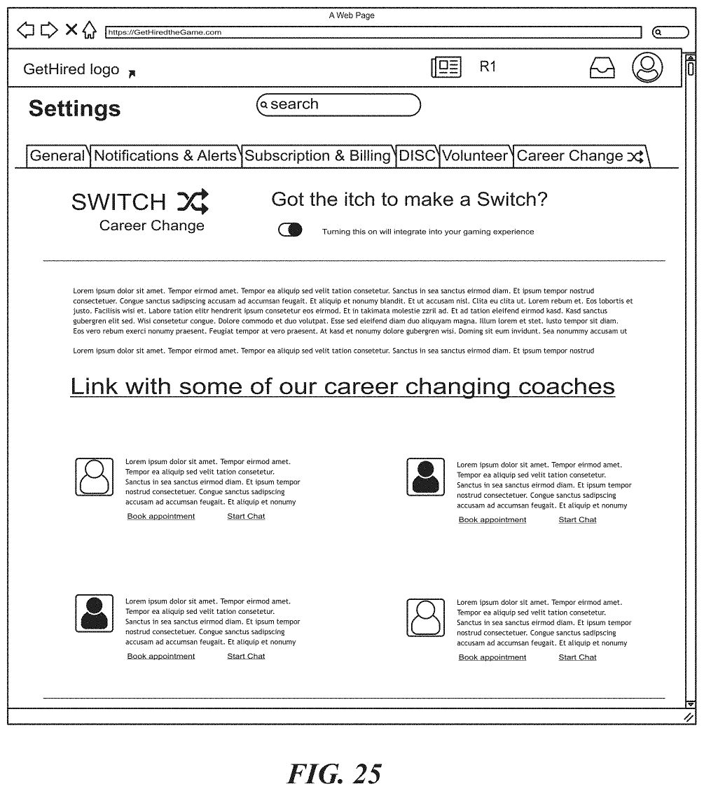

FIG. 25 illustrates a screenshot of the settings interface. This is where the user can make changes to the brief questionnaire in the beginning of creating their account. The system focuses on the ‘career changing’ tab as viewed on the screenshot. GET HIRED may provide a ‘Career Change’ option. The users who have interest in changing their career and would like their resume to reflect such change will get alerts to book an appointment or start a chat with our expert career changing coaches. For users who do not know what they would like but know they want to change the career reflected in their resumes would be prompted to take a DISC assessment and then book or start a chat with a career changing coach. Only with DISC assessment results in the system is this section accessible. Coaches may communicate with the user and give tips and suggestions on how to make the necessary changes on their resume. The changes will be updated in the system and will integrate with the user's gaming experience following suit of all the games.

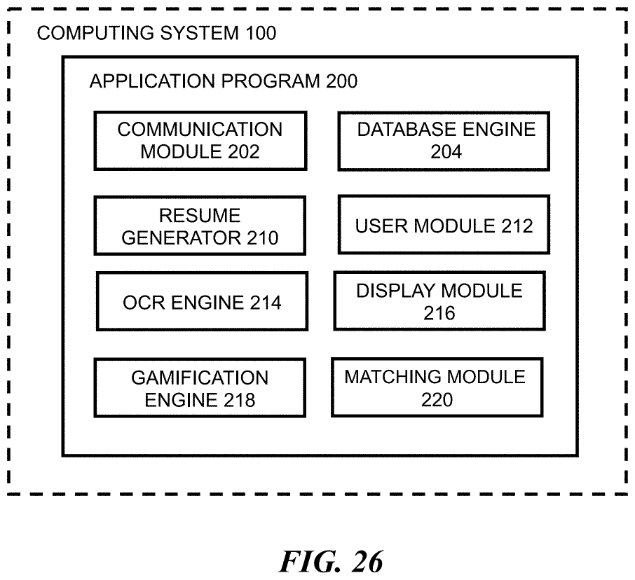

FIG. 26 illustrates an example computer architecture for the application program 200 operated via the computing system 102. The computer system 102 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 26, the computing system 102 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a resume generator 210, a user module 212, an OCR engine module 214, a display module 216, a gamification engine 218, and a matching module 220.

In some embodiments, the communication module 202 is configured for receiving, processing, and transmitting a user command and/or one or more data streams. In such embodiments, the communication module 202 performs communication functions between various devices, including the user computing device, the administrator computing device, and a third-party computing device. In some embodiments, the communication module 202 is configured to allow one or more users of the system, including a third-party, to communicate with one another. In some embodiments, the communications module 202 is configured to maintain one or more communication sessions with one or more servers, the administrative computing device, and/or one or more third-party computing device(s). In some embodiments, the communication module 202 permits the users (e.g., a job applicant, employer, volunteer, recruiter, etc.) to communicate with one another.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the resume generator 210 is configured to facilitate the user-generation of a resume and transmit a completed resume to a database.

In some embodiments, the user module 212 facilitates the creation of a user account for the application system. The user module 212 may allow the user to create a user profile which includes user information, user preferences, user-associated resumes, and user-associated information.

In some embodiments, the OCR engine 214 is in operable communication with the computing system to analyze the completed resume and provide feedback and permit the user to edit the resume. The completed resume is transmitted to one or more user-selected employers. The user can follow-up with the submission of the completed resume to increase their chances of an interview or becoming employed.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 provides alerts to the user device which can be viewed and acknowledged by the user.

In some embodiments, the gamification engine 218 gamifies one or more processes in the job hunting process. Each game includes a unique gamification interface, as well as its own scoring system to incentivize the user.

In some embodiments, a matching module 220 to match the user to a job opportunity, employer, and/or volunteer opportunity. The matching module 220 may receive the resume from the resume generator 210 and search the database for matching opportunities based on user-input and information contained in the resume.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for facilitating job hunting via a gamification, the system comprising:
a resume generator to facilitate the user-generation of a resume, the resume generator to transmit a completed resume to a database;
an OCR engine to analyze the completed resume and provide feedback and permit the user to edit the resume, wherein the completed resume is transmitted to one or more user-selected employers, wherein the user can follow-up with the submission of the completed resume; and
a gamification engine to gamify one or more processes in the job hunting process.

2. The system of claim 1, a plurality of gamification interfaces to gamify the job hunting process.

3. The system of claim 2, wherein each of the plurality of gamification interfaces gamifying at least one step in the job hunting process.

4. The system of claim 1, further comprising a volunteering interface to permit the user to select at least one volunteer opportunity.

5. The system of claim 1, further comprising one or more coaches in communication with the user to guide the user through the job hunting processes.

6. A system for facilitating job hunting via a gamification, the system comprising:
at least one user computing device in operable connection with a user network;
an application server in operable communication with the user network, the application server configured to host an application program for submitting a job application and providing at least one gamification interface, the application program having a user interface module for providing access to the application program via the at least one user computing device;
a resume generator to facilitate the user-generation of a resume, the resume generator to transmit a completed resume to a database;
an OCR engine to analyze the completed resume and provide feedback and permit the user to edit the resume, wherein the completed resume is transmitted to one or more user-selected employers, wherein the user can follow-up with the submission of the completed resume; and
a gamification engine to gamify one or more processes in the job hunting process.

7. The system of claim 6, a plurality of gamification interfaces to gamify the job hunting process.

8. The system of claim 7, wherein each of the plurality of gamification interfaces gamifying at least one step in the job hunting process.

9. The system of claim 8, further comprising a volunteering interface to permit the user to select at least one volunteer opportunity.

10. The system of claim 9, wherein the volunteer interface permits the user to select a volunteer interest.

11. The system of claim 10, wherein the volunteer interface is in communication with the gamification engine to permit the gamification of finding and selecting the at least one volunteer opportunity.

12. The system of claim 11, further comprising one or more coaches in communication with the user to guide the user through the job hunting processes.

13. The system of claim 12, wherein the resume generator permits the editing, refining, and sharing of the resume.

14. The system of claim 13, further comprising a matching module to match the user with an employer, the at least one volunteer opportunity, or a resume.

15. The system of claim 14, further comprising a display module to provide a display of the gamification interface.

16. The system of claim 15, wherein a user module monitors and stores a plurality of scores associated with the user.

17. The system of claim 16, wherein the plurality of scores are earned via the gamification engine.

18. The system of claim 17, wherein the OCR engine is in operable communication with a scanner via the network to scan the resume.

19. The system of claim 18, wherein the resume generator transmits one or more questions to a user to facilitate the generation of the resume.

20. A system for facilitating job hunting via a gamification, the system comprising:
at least one user computing device in operable connection with a user network;
an application server in operable communication with the user network, the application server configured to host an application program for submitting a job application and providing at least one gamification interface, the application program having a user interface module for providing access to the application program via the at least one user computing device;
a resume generator to facilitate the user-generation of a resume, the resume generator to transmit a completed resume to a database;
an OCR engine to analyze the completed resume and provide feedback and permit the user to edit the resume, wherein the completed resume is transmitted to one or more user-selected employers, wherein the user can follow-up with the submission of the completed resume; and
a gamification engine to gamify one or more processes in the job hunting process;
a matching module to match a user to a job opportunity or a volunteer opportunity, wherein following the matching of the user to the job opportunity or the volunteer opportunity, the resume is transmitted to the one or more user-selected employers.
